(19) United States
(12) Patent Application Publication
(10) Pub. No.: US 2003/0101196 A1
(43) Pub. Date: May 29, 2003

(54) Data processing

(76) Inventor: Jason Paul Woodard, Cambridge (GB)

Correspondence Address: BANNER & WITCOFF, LTD., TEN SOUTH WACKER DRIVE, SUITE 3000, CHICAGO, IL, 60606, US

(21) Appl. No.: 10/258,569

(22) PCT Filed: Apr. 24, 2001
(86) PCT No.: PCT/GB01/01821

(30) Foreign Application Priority Data
Apr. 25, 2000 (GB) 0010082.6

(51) Int. Cl. G06F 7/00

(52) U.S. Cl. 707/102

(57) ABSTRACT

Data items in a memory list (12) are de-interleaved or interleaved by sorting them to new positions in the list. A flag (f1-f6) indicates whether an item has been read for sorting and overwriting is not permitted until the contents of a position have been read for sorting.

This invention relates to data processing. In particular, this invention relates to the sorting of a list of data items into a desired order.

It is known to interleave data for wireless transmission in order to minimise the effect of errors and enhance data recoverability. Data to be transmitted is buffered in the order in which it is to be read. The data is then interleaved, i.e. sorted into a different order for transmission. The transmitted data is received at its destination and de-interleaved into the order in which it is to be read. The loss of consecutive data items in the transmission stream will not, in general, correspond to consecutive errors in the de-interleaved data sequence. This is advantageous because it is easier to correct isolated errors in a data stream.

A conventional interleaver buffers the data to be transmitted, in the sequence in which they are to be read, in a first memory area. The interleaving process then transfers each of the data items from the first memory area to a position in a second memory area such that the second memory area presents the data items in the interleaved order ready for transmission. The corresponding conventional de-interleaver operates in a similar way, transferring interleaved received data from a first memory area to a second memory area where they are listed in the order in which they are to be read.

A drawback with the conventional interleaver/de-interleaver described above is that two memory areas are used, each of a capacity sufficient to store the entire list of data items being interleaved/de-interleaved.

It is an object of the present invention to achieve data sorting in a more memory-efficient manner.

According to one aspect, the invention provides a method of processing data, comprising sorting a list of data items within a set of memory locations from a first order to a second order by sorting each data item into its sorted position after the contents of the sorted position have been read for sorting.

The invention thus provides for more efficient use of a memory storing the list.

Advantageously, the data processing method comprises the step of examining if the contents of a list position have been read for sorting prior to writing a sorted data item into that position. Preferably, this is achieved by examining the state of an indicator or flag associated with the list position. Thus, overwriting of unsorted data items is avoided. Where the contents of a position are examined in this way, it may be provided that, if the contents of the examined position have not been read for sorting, then the contents of the examined position are read prior to writing the sorted data item into the examined position. Advantageously, the displaced content of the examined position is then treated as the subject of the next sorting step. On the other hand, where the contents of the examined position have already been read for sorting, the sorted data item can be written directly into the examined position and then a list position whose contents have not already been read for sorting is selected as the subject of the next sorting step.

Advantageously, the data processing method may be used to interleave a list of data items (preferably, for transmission), or to de-interleave a list of data items (preferably, for receiving transmitted data). The invention also extends to a program for carrying out any of the aforementioned data processing methods.

According to another aspect, the invention also provides data management apparatus for sorting a list of data items into a desired order, comprising means for storing a list of data items, and processing means for sorting data items within a set of memory locations from a first order to a second order, said processing means being arranged to sort a data item to its sorted position after the contents of the sorted position have been read for sorting.

The data management apparatus according to the invention provides for the efficient use of the storage means containing the list of data items in that the amount of storage used may be reduced.

Preferably, the processing means is arranged to refer to an indicating means to determine if the contents of a selected position in the list have been read for sorting. Preferably, the indicating means comprises a flag for each position in the list.

Where the processing means refers to an indicating means, it is desirable that the processing means be arranged to read the contents of the selected position prior to writing the sorted item into it if it is determined that the contents of the selected position have not already been read for sorting. It is also advantageous for the processing means to treat the displaced contents of the selected position as the subject of the next sorting operation.

Where the processing means is arranged to refer to an indicating means to determine if the contents of a selected position of the list have been read, it is desirable to provide the processing means with the ability to write the sorted item directly into the selected position in the case where the contents of the selected position have already been read for sorting, and, preferably, seek a data item in the list which has not been previously read for sorting.

In one preferred embodiment, the data management apparatus is an interleaver for interleaving a list of data items. The invention also extends to a transmitter including this sort of interleaver.

In another preferred embodiment, the data management apparatus is a de-interleaver for de-interleaving a list of data items. The invention also extends to a receiver including a de-interleaver of this type.

By way of example only, an embodiment of the invention will now be described with reference to the accompanying figures, in which:

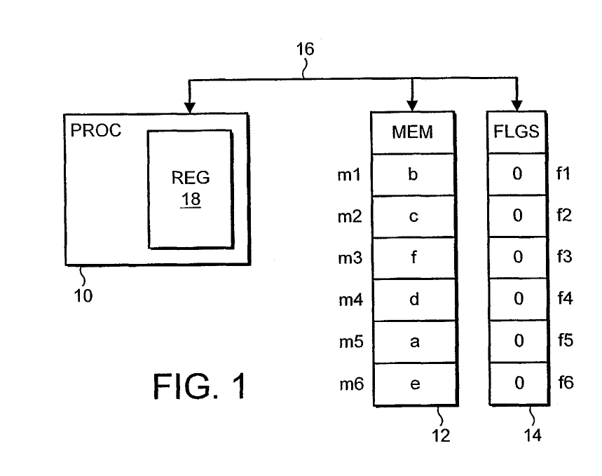

FIG. 1 illustrates schematically part of the processing circuitry within a de-interleaver; and

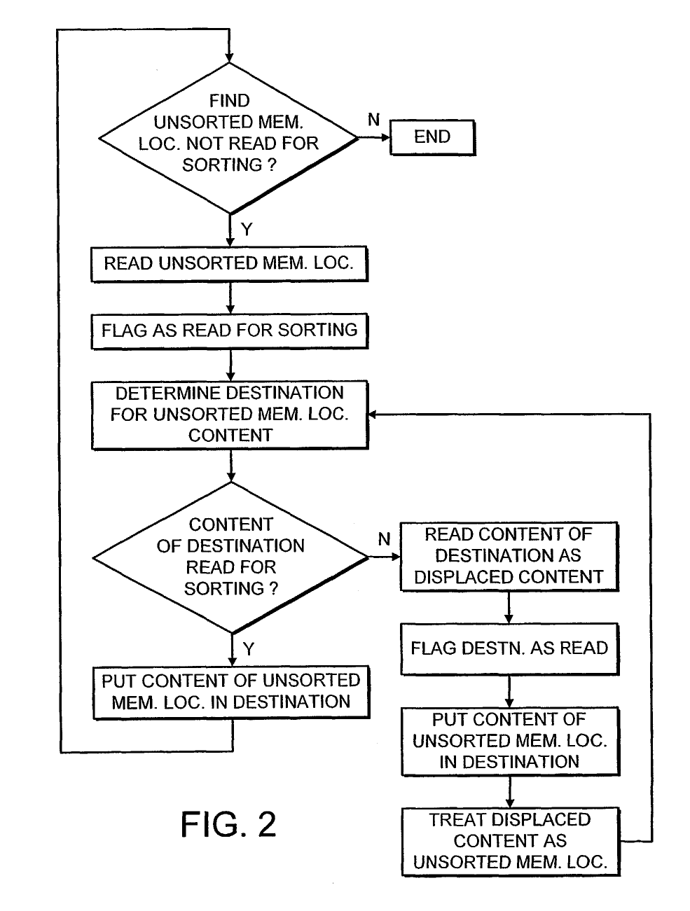

FIG. 2 is a flowchart illustrating the processing performed by the circuitry of FIG. 1.

The portion of the de-interleaver shown in FIG. 1 comprises a processor 10 connected to two memories 12 and 14 via a bus 16.

The memory 12 comprises a sequence of memory locations m1 to m6 which store data items b, c, f, etc. which are to be de-interleaved. The other memory 14 contains an entry or flag f1 to f6 corresponding to each of the locations m1 to m6 in the memory 12. Each of the flags f1 to f6 in the flag memory 14 indicates whether or not its corresponding location in memory 12 has been read for sorting or not. FIG. 1 shows the initial condition of memory 14 wherein all of the flags are set to zero indicating that none of the memory locations m1 to m6 have yet been read for sorting. The processor 10 is programmed to perform the desired type of interleaving and contains registers 18 for temporarily storing data read from memory 12.

Processor 10 is programmed to perform a de-interleaving process whereby the contents of memory locations m1 to m6 in memory 12 are sorted into memory locations m2, m3, m6, m4, m1 and m5 respectively. The interleaving process is selected to undo an interleaving process used by a transmitter from which the data in memory 12 has been received. In other words, the processor 10 is arranged to operate a de-interleaving algorithm which reorders data items b, c, f, d, a, e to a, b, c, d, e, f. It should be noted that the labels a, b, c, d, e, f do not indicate the actual information content of the memory slots m1 to m6.

First, the processor 10 examines flag f1 (which is set to zero) and infers that m1 has not been read for sorting. The value of m1 (b) is read into one of the registers 18. Flag f1 is then changed to 1 to indicate that m1 has been read for sorting. In accordance with its de-interleaving algorithm, the processor 10 determines that b is to be written into m2. The processor therefore examines flag f2 and finds that it is also set to zero. To avoid overwriting value of m2, which, as indicated by f2, has not yet been sorted to its correct position, the value of m2 (e) is read into one of the registers 18. Flag f3 is then set to 1. The data b is then written into m2.

The processor 10 then operates on the value c, which is the displaced content of m2. The processor 10 determines that the value c is to be placed in m3. The processor 10 inspects f3, which is set to zero. The processor therefore loads the present value of m3 (f) into one of the registers 18 and changes f3 to 1. The processor 10 then stores value c in m3.

The processor 10 then determines the correct location for the value f according to its de-interleaving algorithm. The de-interleaved position for f is m6. The processor 10 examines f6 and finds that it is set to zero. The processor 10 therefore reads the value of m6 (e) into one of the registers 18 and sets f6 to 1. The processor 10 then writes f into m6.

Processor then determines the de-interleaved position of the value e displaced from m6 according to its de-interleaving algorithm. The required position is m5. The processor 10 examines f5, finds that it is zero, and reads the value of m5 (a) into one of the registers 18. The processor 10 then places the value e in m5.

The processor 10 then determines the de-interleaved position of the displaced content of m5. The correct position is m1. Presently, the content of m1 is b. However, processor 10, upon reading f1, finds that its value is 1, indicating that m1 has already been read for sorting. Therefore, the processor 10 proceeds with overwriting b in m1 with a. The processor has reached the end of a closed loop since there is no value displaced from m1.

The processor 10 then proceeds to look down the flag memory 14 to find a flag indicating that the corresponding location in memory 12 has not been sorted to a de-interleaved position. The processor 10 finds that f4 is zero. The processor 10 reads the value d from m4 into one of its registers 18 and sets f4 to 1. According to its de-interleaving algorithm, the processor 10 must assign the value of m4 back to m4. Therefore, the processor inspects f4, finds that it is set to 1, indicating that the contents of m4 have been read for sorting already, and overwrites d in m4 with d. The processor 10 therefore completes another closed loop, this time of the shortest possible type. The processor may be arranged to recognise when it is about to write the contents of a location of memory 12 back to the same location and inhibit the writing operation, thus saving processing time. This is a variation on the basic system.

The processor 10 then reviews the flag memory 14 for a flag set to zero. Since there are none, the processor concludes that the de-interleaving of the contents of memory 12 has been completed. The de-interleaved content of memory 12 may then be read in the correct order by a connected piece of apparatus using the data for a predetermined task. New data may then be loaded into m1 to m6 and the processor may then begin the de-interleaving program again, with f1 to f6 reset to zero.

The de-interleaving process may be understood further from the flowchart of FIG. 2, which is self explanatory.

Although the de-interleaving apparatus described with reference to FIG. 1 involved only 6 memory locations m1 to m6, it will be appreciated that this number is arbitrary and that fewer or more memory locations could be involved in the de-interleaving process.

In addition, from the foregoing description of a de-interleaver with the respect to FIGS. 1 and 2, it will also be appreciated that an interleaver (for example, forming part of a transmitter) may be arranged to operate in an analogous fashion. For example, the order b, c, f, d, a, e could be the order in which the data is to be used and the order a, b, c, d, e, f could be the interleaved order for transmission.

It will be apparent that a fixed sequence of reading and writing operations amongst the memory locations of the list is required for a particular type of interleaving/de-interleaving. The present system could therefore be provided with the required sequence for the type of interleaving being used, thus dispensing with the flag memory 14. However, the use of the flag memory 14 provides for transparency in the operation of the (de) interleaver.

1. A method of processing data, comprising sorting a list of data items within a set of memory locations from a first order to a second order by sorting each data item into its sorted position after the contents of the sorted position have been read for sorting.

2. A method of processing data according to claim 1, comprising examining an indicator associated with a list position prior to sorting a data item into that position, said indicator indicating whether the content of the associated list position has been read for sorting.

3. A method of processing data according to claim 1 or claim 2, comprising reading a data item from its list position before sorting a data item into that position if the current content of that position has not been read for sorting.

4. A method of processing data according to any preceding claim, comprising seeking an unsorted data item in the list after a data item has been sorted into a list position whose content has already been sorted.

5. A method according to any preceding claim, wherein the sorting procedure comprises arranging the list in a de-interleaved order.

6. A method according to any one of claims 1 to 4, wherein the sorting procedure comprises arranging the list in an interleaved order.

7. A program for performing the method of any preceding claim.

8. Data management apparatus for sorting a list of data items into a desired order, comprising means for storing a list of data items and processing means for sorting data items within a set of memory locations from a first order to a second order, said processing means being arranged to sort a data item to its sorted position after the contents of the sorted position have been read for sorting.

9. Data management apparatus according to claim 8, wherein the processing means is arranged to refer to an indicating means to determine if the content of a selected list position has been read for sorting.

10. Data management apparatus according to claim 8 or claim 9, wherein the processing means is arranged to read a data item from its list position before sorting a data item into that position if the current content of that position has not been read for sorting.

11. Data management apparatus according to any one of claims 8,9 or 10, wherein the processing means is arranged to seek an unsorted data item in the list after a data item has been sorted into a list position whose content has already been sorted.

12. Data management apparatus according to any one of claims 8 to 11, wherein the sorting procedure implemented by the processing means is a de-interleaving process.

13. Data management apparatus according to any one of claims 8 to 11, wherein the sorting procedure implemented by the processing means is an interleaving process.

14. A method of processing data substantially as hereinbefore described with reference to the accompanying figures.

15. Data management apparatus substantially as hereinbefore described with reference to the accompanying figures.
